(19) United States
(12) Patent Application Publication
(10) Pub. No.: US 2010/0303158 A1
(43) Pub. Date: Dec. 2, 2010

(54) METHOD AND APPARATUS FOR SCENE CHANGE DETECTION

(75) Inventor: Shu Lin, Santa Clarita, CA (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-billancourt (FR)

(21) Appl. No.: 12/303,428

(22) PCT Filed: Jun. 8, 2006
(86) PCT No.: PCT/US06/22341

§ 371 Date: Dec. 4, 2008

(51) Int. Cl. H04N 5/14; H04N 7/26

(52) U.S. Cl. 375/240.26; 348/700; 375/E07.026; 348/E05.062

(57) ABSTRACT

An apparatus and method for detecting scene change by using a sum of absolute histogram difference (SAHD) and a sum of absolute display frame difference (SADFD). The apparatus and method use the temporal information in the same scene to smooth out the variations and accurately detect scene changes. The apparatus and method can be used far both real-time (e.g., real-time video compression) and non-real-time (e.g., film post-production) applications.

### FIELD OF THE INVENTION

The present invention relates to video processing and, more particularly, to a method and apparatus for detecting scene changes.

### BACKGROUND OF THE INVENTION

This section is intended to introduce the reader to various aspects of art that may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Motion picture video content data is generally captured, stored, transmitted, processed, and output as a series of still images. Small frame-by-frame data content changes are perceived as motion when the output is directed to a viewer at sufficiently close time intervals. A large data content change between two adjacent frames is perceived as a scene change (e.g., a change from an indoor to an outdoor scene, a change in camera angle, an abrupt change in illumination within an image, and the like).

Encoding and compression processes take advantage of small frame-by-frame video content data changes to reduce the amount of data needed to store, transmit, and process video data content. The amount of data required to describe the changes is less than the amount of data required to describe the original still image. Under standards developed by the Moving Pictures Experts Group (MPEG), for example, a group of frames begins with an intra-coded frame (I-frame) in which encoded video content data corresponds to visual attributes (e.g., luminance, chrominance) of the original still image. Subsequent frames in the group of frames, such as predictive coded frames (P-frames) and bi-directional coded frames (B-frames), are encoded based on changes from earlier frames in the group. New groups of frames, and thus new I-frames, are begun at regular time intervals to prevent, for instance, noise from inducing false video content data changes. New groups of frames, and thus new I-frames, are also begun at scene changes when the video content data changes are large because less data is required to describe a new still image than to describe the large changes between the adjacent still images. In other words, two pictures from different scenes have little correlation between them. Compression of the new picture into an I-frame is more efficient than using one picture to predict the other picture. Therefore, during content data encoding, it is important to identify scene changes between adjacent video content data frames.

It should also be noted that the identification of scene changes is also relevant in film post-production processing. For example, color correction processing, one type of post-production processing, is typically applied to motion picture video content data on a scene-by-scene basis. As a result, quick and accurate detection of scene boundaries is critical.

Several processes exist to identify scene changes between two video content frames. Motion-based processes compare vector motion for blocks of picture elements (pixels) between two frames to identify scene changes. Histogram-based processes map, for example, the distribution of pixel color data for the two frames and compare the distributions to identify scene changes. Picture feature-based processes identify a given object (e.g., an actor, a piece of scenery or the like) in a video content data frame to determine if the defined attributes of the object are associated with a predetermined scene classification. However, each process has drawbacks. For example, motion-based processes are often very time-consuming requiring multiple clock cycles and dedicated processor bandwidth. Histogram-based processes, when used exclusively, are often inaccurate and incorrectly detect scene changes. Finally, picture feature-based processes are often even more difficult and time-consuming than motion-based processes.

The present invention is directed towards overcoming these drawbacks.

### SUMMARY OF THE INVENTION

The present invention is directed towards an apparatus and method for detecting scene change by using a Sum of Absolute Histogram Difference (SAHD) and a Sum of Absolute Display Frame Difference (SADFD). The present invention uses the temporal information in the same scene to smooth out variations and accurately detect scene changes. The present invention can be used for both real-time (e.g., real-time video compression) and non-real-time (e.g., film post-production) applications.

These and other advantages and features of the invention will become readily apparent to those skilled in the art after reading the following detailed description of the invention and studying the accompanying drawings.

### BRIEF DESCRIPTION OF THE DRAWINGS

FIG. 1 is a block diagram illustrating an exemplary system using the scene detection module of the present invention;

FIG. 2 is a block diagram illustrating another exemplary system using the scene detection module of the present invention; and

FIG. 3 is a flowchart illustrating the scene detection process of the present invention.

### DETAILED DESCRIPTION

The following is a detailed description of the presently preferred embodiments of the present invention. However, the present invention is in no way intended to be limited to the embodiments discussed below or shown in the drawings. Rather, the description and the drawings are merely illustrative of the presently preferred embodiments of the invention.

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

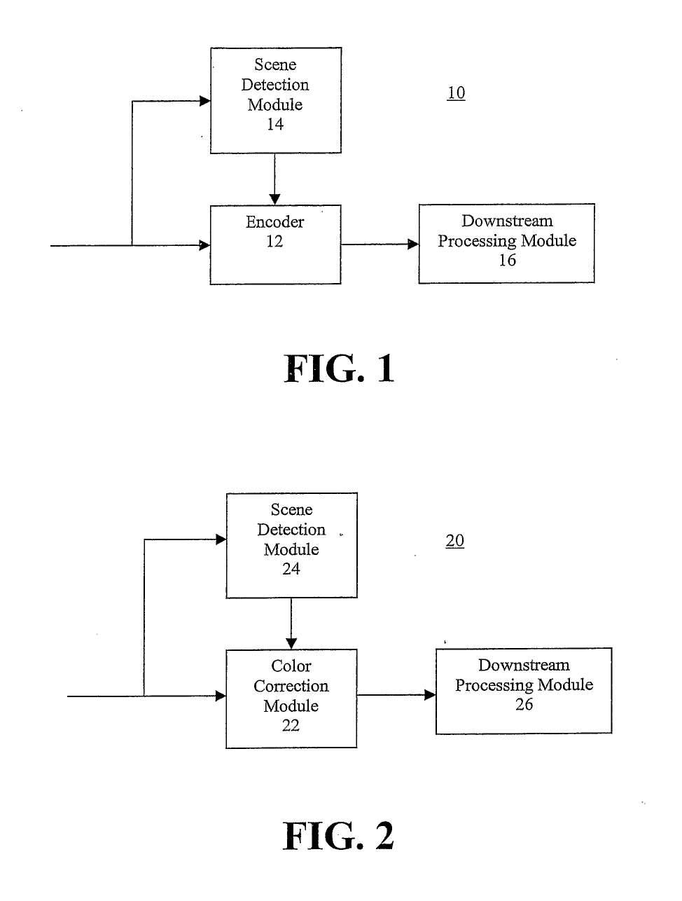

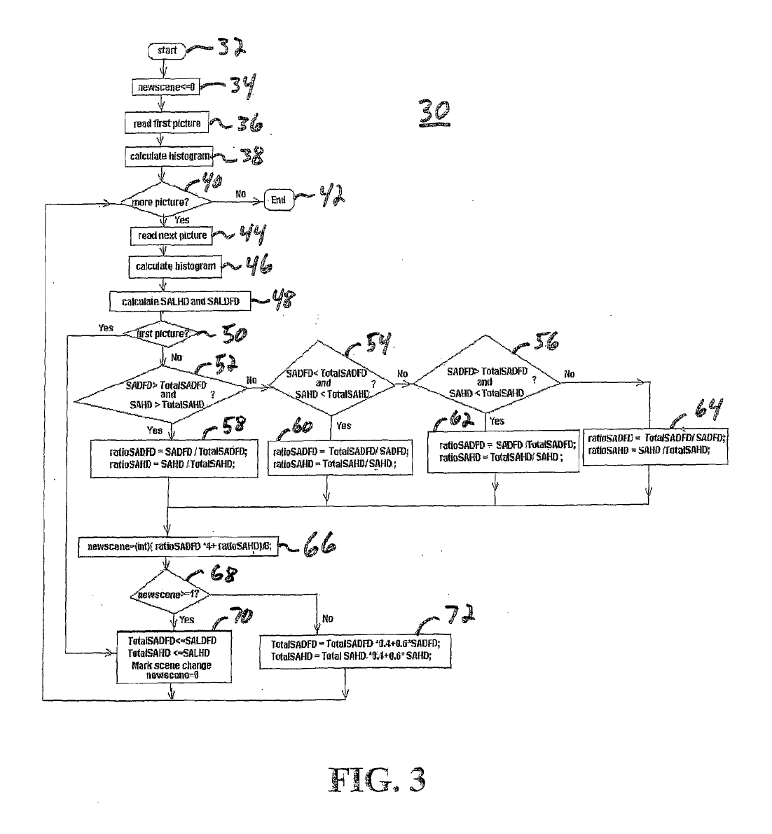

Referring now to FIG. 1, a block diagram showing an embodiment of the present invention used in an encoding arrangement or system 10 is shown. Encoding arrangement 10 includes an encoder 12, such as an Advanced Video Encoding (AVC) encoder, operatively connected to a scene detection module 14 and downstream processing module 16. At its input encoder 12 receives an uncompressed motion picture video content datastream containing a series of still image frames. Utilizing a control signal received from scene detection module 14, encoder 12, operating in accordance with standards developed by the Moving Pictures Experts Group (MPEG), for example, converts the uncompressed datastream into a compressed datastream containing a group of frames beginning with an intra-coded frame (I-frame) in which encoded video content data corresponds to visual attributes (e.g., luminance, chrominance) of the original uncompressed still image. Subsequent frames in the group of frames, such as predictive coded frames (P-frames) and bi-directional coded frames (B-frames), are encoded based on changes from earlier frames in the group. As discussed previously, new groups of frames, and thus new I-frames, are begun at scene changes when the video content data changes are large because less data is required to describe a new still image than to describe the large changes between the adjacent still images. Using the detection process of the present invention, described in further detail below and shown in FIG. 3, scene detection module 14 detects a new scene in the received uncompressed motion picture video content datastream and transmits a control signal to encoder 12 indicating that a new group of frames needs to be encoded. The control signal may include timestamps, pointers, synchronization data, or the like to indicate when and where the new group of frames should occur. After the uncompressed data stream is compressed by encoder 12, the compressed datastream is passed to a downstream processing module 16 that performs additional processing on the compressed data so the compressed data can be stored (e.g., in a hard disk drive (HDD), digital video disk (DVD), high definition digital video disk (HD-DVD) or the like), transmitted over a medium (e.g., wirelessly, over the Internet, through a wide area network (WAN) or local area network (LAN) or the like), or displayed (e.g., in a theatre, on a digital display (e.g., a plasma display, LCD display, LCOS display, DLP display, CRT display) or the like).

Referring now to FIG. 2, a block diagram showing an embodiment of the present invention used in a color correction arrangement or system 20 is shown. Color correction arrangement 20 includes a color correction module 22, such as an Avid, Adobe Premiere or Apple FinalCut color correction module, operatively connected to a scene detection module 24 and downstream processing module 26. At its input color correction module 30 receives an uncompressed motion picture video content datastream containing a series of still image frames. Utilizing a control signal received from scene detection module 24, color correction module 22 color corrects the scenes in the received datastream and passes the color corrected datastream to downstream processing module 26. Downstream processing module 26 may apply additional post-production processes such as contrast adjustment, film grain adjustment (e.g., removal and insertion), and the like to the color corrected datastream. It should be appreciated that the additional post-production processes and systems may also use the scene detection process of the present invention. Using the detection process of the present invention, described in further detail below and shown in FIG. 3, scene detection module 24 detects a new scene in the received uncompressed motion picture video content datastream and transmits a control signal to encoder 12 indicating that a new scene needs to be color corrected. The control signal may include timestamps, pointers, synchronization data, or the like to indicate the position of the new scene.

Referring now to FIG. 3, the detection process 30 of the present invention is shown. The scene detection process 30 is used to identify or detect scene changes or scene boundaries. Upon startup, at step 32, the scene detection module, at step 34, sets a newscene value equal to zero. Next, at step 36, the scene detection module reads in a first picture from a received uncompressed motion picture video content datastream. The scene detection module, at step 38, calculates the first picture's histogram by, for example, counting the number of pixels within the first picture matching a predetermined color channel value. Next, at step 40, the scene detection module determines if there are more pictures to be read in from the received uncompressed motion picture video content datastream. If not, the scene detection module, at step 42, ends the scene detection process 30. If so, the scene detection module, at step 44, reads in the next picture from the received uncompressed motion picture video content datastream and, at step 46, calculates the picture's histogram. Next, at step 48, the scene detection module calculates the sum of the absolute display frame difference (SADFD) and the sum of the absolute histogram difference (SAHD) between the adjacent pictures.

For example, the SADFD for the first two pictures would be calculated using the following formula:

SADFD=Σ^{M-1}ᵢ₌₀Σ^{N-1}ⱼ₌₀|p₁(i,j)−p₂(i,j)|

Where M is the width of a picture and N is the height of the picture. P₁(i,j) is the one channel value at pixel (i,j) of the first picture, and P₂(i,j) is that of the second picture.

The SAHD for the first two pictures would be calculated using the following formula:

SAHD=Σ²⁵⁵ᵢ₌₀|H₁(i)−H₂(i)|

Where H₁(i) is the number of pixels that have the value of i in the first picture one channel, and H₂(i) is that of the second picture.

It should be noted that when the SADFD is less than four a false scene change may be detected. In order to avoid such false scene change detections, the SADFD is set equal to four if the calculated SADFD is less than four.

At step 50, the scene detection module determines if the picture being processed is a first picture in a new scene. If so, at step 70, the accumulated total values for the SADFD and SAHD are set to zero and the scene detection module returns to step 40 to receive the next picture of the uncompressed motion picture video content datastream. If not, the scene detection module accumulates a total SADFD and total SAHD using a weighted formula. Exemplary weighted formulas that have been found to yield accurate scene detection results are:

TotalSADFD=TotalSADFD*0.4+0.6*SADFD

TotalSAHD=TotalSAHD*0.4+0.6*SAHD

Weight values other that 0.4 and 0.6 may be used, however, these weight values have been found to generate accurate scene detection results.

Next, to detect the presence of a scene change the scene detection module, at steps 52-68, executes a series of selected tests. More specifically, each test utilizes a ratio of a currently read picture's SADFD to an accumulated TotalSADFD and a ratio of the currently read picture's SAHD to an accumulated TotalSAHD.

A first scene detection test starts at step 52, wherein the scene detection module determines if a currently read picture's SADFD is greater than the accumulated TotalSADFD and if the currently read picture's SAHD is greater than the accumulated TotalSAHD. If not, the scene detection module initiates a second scene detection test at step 54 and described in further detail below. If so, the scene detection module, at step 58, generates a SADF-based ratio and a SAHD-based ratio. More specifically, the generated ratios are as follows:

ratioSADFD=SADFD/TotalSADFD

ratioSAHD=SAHD/TotalSAHD

Next, at step 66, the scene detection module calculates a new scene value as follows:

newscene=(int)(ratioSADFD*4+ratioSAHD)/8

Then, at step 68, the scene detection module determines if the calculated new scene value is greater than or equal to one. If the new scene value is greater than or equal to one, the scene detection module generates a control signal, as discussed in FIGS. 2 and 3, and, at step 70, resets the accumulated total values for the SADFD and SAHD to zero and returns to step 40 to receive the next picture of the uncompressed motion picture video content datastream. If the new scene value is less than 1 the scene detection module, at step 72, adjusts the total SADFD and total SAHD as follows:

TotalSADFD=TotalSADFD*0.4+0.6*SADFD

TotalSAHD=TotalSAHD*0.4+0.6*SAHD

Weight values other that 0.4 and 0.6 may be used, however, these weight values have been found to generate accurate scene detection results. Afterwards, the scene detection module returns to step 40 to receive the next picture of the uncompressed motion picture video content datastream.

If, at step 52, the scene detection module determines that either the currently read picture's SADFD is not greater than the accumulated TotalSADFD or the currently read picture's SAHD is not greater than the accumulated TotalSAHD, the scene detection module, at step 54, initiates a second scene detection test. At step 54, the scene detection module determines if a currently read picture's SADFD is less than the accumulated TotalSADFD and if the currently read picture's SAHD is less than the accumulated TotalSAHD. If not, the scene detection module initiates a third scene detection test at step 56 and described in further detail below. If so, the scene detection module, at step 60, generates a SADF-based ratio and a SAHD-based ratio. More specifically, the generated ratios are as follows:

ratioSADFD=TotalSADFD/SADFD

ratioSAHD=TotalSAHD/SAHD

Next, at step 66, the scene detection module calculates a new scene value as follows:

newscene=(int)(ratioSADFD*4+ratioSAHD)/8

Then, at step 68, the scene detection module determines if the calculated new scene value is greater than or equal to one. If the new scene value is greater than or equal to one, the scene detection module generates a control signal, as discussed in FIGS. 2 and 3, and, at step 70, resets the accumulated total values for the SADFD and SAHD to zero and returns to step 40 to receive the next picture of the uncompressed motion picture video content datastream. If the new scene value is less than 1 the scene detection module, at step 72, adjusts the total SADFD and total SAHD as follows:

TotalSADFD=TotalSADFD*0.4+0.6*SADFD

TotalSAHD=TotalSAHD*0.4+0.6*SAHD

Weight values other that 0.4 and 0.6 may be used, however, these weight values have been found to generate accurate scene detection results. Afterwards, the scene detection module returns to step 40 to receive the next picture of the uncompressed motion picture video content datastream.

If, at step 54, the scene detection module determines that either the currently read picture's SADFD is not less than the accumulated TotalSADFD or the currently read picture's SAHD is not less than the accumulated TotalSAHD, the scene detection module, at step 56, initiates a third scene detection test. At step 56, the scene detection module determines if a currently read picture's SADFD is greater than the accumulated TotalSADFD and if the currently read picture's SAHD is less than the accumulated TotalSAHD. If not, the scene detection module determines that the currently read picture's SADFD is less than the accumulated TotalSADFD and the currently read picture's SAHD is greater than the accumulated TotalSAHD and initiates a fourth scene detection test at step 64 and described in further detail below. If so, the scene detection module, at step 62, generates a SADF-based ratio and a SAHD-based ratio. More specifically, the generated ratios are as follows:

ratioSADFD=SADFD/TotalSADFD

ratioSAHD=TotalSAHD/SAHD

Next, at step 66, the scene detection module calculates a new scene value as follows:

newscene=(int)(ratioSADFD*4+ratioSAHD)/8

Then, at step 68, the scene detection module determines if the calculated new scene value is greater than or equal to one. If the new scene value is greater than or equal to one, the scene detection module generates a control signal, as discussed in FIGS. 2 and 3, and, at step 70, resets the accumulated total values for the SADFD and SAHD to zero and returns to step 40 to receive the next picture of the uncompressed motion picture video content datastream. If the new scene value is less than 1 the scene detection module, at step 72, adjusts the total SADFD and total SAHD as follows:

TotalSADFD=TotalSADFD*0.4+0.6*SADFD

TotalSAHD=TotalSAHD*0.4+0.6*SAHD

Weight values other that 0.4 and 0.6 may be used, however, these weight values have been found to generate accurate scene detection results. Afterwards, the scene detection module returns to step 40 to receive the next picture of the uncompressed motion picture video content datastream.

As discussed above, if the scene detection module determines that the currently read picture's SADFD is less than the accumulated TotalSADFD and the currently read picture's SAHD is greater than the accumulated TotalSAHD the scene detection module, at step 64, generates a SADF-based ratio and a SAHD-based ratio. More specifically, the generated ratios are as follows:

ratioSADFD=TotalSADFD/SADFD;

ratioSAHD=SAHD/TotalSAHD

Next, at step 66, the scene detection module calculates a new scene value as follows:

newscene=(int)(ratioSADFD*4+ratioSAHD)/8

Then, at step 68, the scene detection module determines if the calculated new scene value is greater than or equal to one. If the new scene value is greater than or equal to one, the scene detection module generates a control signal, as discussed in FIGS. 2 and 3, and at step 70, resets the accumulated total values for the SADFD and SAHD to zero and returns to step 40 to receive the next picture of the uncompressed motion picture video content datastream. If the new scene value is less than 1 the scene detection module, at step 72, adjusts the total SADFD and total SAHD as follows:

TotalSADFD=TotalSADFD*0.4+0.6*SADFD

TotalSAHD=TotalSAHD*0.4+0.6*SAHD

Weight value's other that 0.4 and 0.6 may be used, however, these weight values have been found to generate accurate scene detection results. Afterwards, the scene detection module returns to step 40 to receive the next picture of the uncompressed motion picture video content datastream.

As described above, the present invention is described as using a combination of Sum of Absolute Histogram Difference (SAHD) and Sum of Absolute Display Frame Difference (SADFD). Components used to generate these differences can include, but are not limited to, luminance, chrominance, R, G, B, or any other video component.

While the present invention has been described in terms of a preferred embodiment above, those skilled in the art will readily appreciate that numerous modifications, substitutions and additions may be made to the disclosed embodiment without departing from the spirit and scope of the present invention. For example, the apparatus and method described herein may be implemented in hardware, software or a combination of hardware and software. It is intended that all such modifications, substitutions and additions fall within the scope of the present invention which is best defined by the claims below.

1. A method for identifying a scene change, said method comprising the steps of:
receiving a datastream containing a plurality of scenes, each scene containing a plurality of pictures;
calculating a sum of the absolute histogram difference between a pair of adjacent pictures;
calculating a sum of the absolute display frame difference between said pair of adjacent pictures; and
determining if a scene boundary exists between said pair of adjacent pictures using said sum of the absolute histogram difference and said sum of the absolute display frame difference.

2. The method of claim 1, wherein the step of determining includes the steps of:
comparing said sum of the absolute histogram difference to an accumulated total of sum of the absolute histogram differences; and
comparing said sum of the absolute display frame difference to an accumulated total of sum of the absolute display frame differences.

3. The method of claim 2, wherein the step of determining includes the steps of:
generating a sum of the absolute histogram difference ratio based on said comparison of said sum of the absolute histogram difference to said accumulated total of sum of the absolute histogram differences; and
generating a sum of the absolute display frame difference ratio based on said comparison of said sum of the absolute display frame difference to said accumulated total of sum of the absolute display frame differences.

4. The method of claim 3, wherein the step of determining includes the steps of:
combining said sum of the absolute histogram difference ratio with said sum of the absolute display frame difference ratio; and
determining that said scene boundary exists if said combination is at least equal to a predetermined limit.

5. The method of claim 1, wherein said method is incorporated into a post-production process.

6. The method of claim 5, wherein the post-production process is color correction.

7. The method of claim 5, wherein the post-production process is contrast adjustment.

8. The method of claim 5, wherein the post-production process is film grain adjustment.

9. The method of claim 1, wherein said method is incorporated into an encoding process.

10. An apparatus for detecting a scene change, said apparatus comprising:
means for receiving a datastream containing a plurality of scenes, said scenes containing a plurality of pictures;
means for calculating a sum of the absolute histogram difference between adjacent pictures;
means for calculating a sum of the absolute display frame difference between adjacent pictures; and
means for determining if a scene change is occurring between adjacent pictures using said sum of the absolute histogram difference and said sum of the absolute display frame difference.

11. The apparatus of claim 10, wherein said means for determining comprises:
means for comparing said sum of the absolute histogram difference to an accumulated total of sum of the absolute histogram differences; and
means for comparing said sum of the absolute display frame difference to an accumulated total of sum of the absolute display frame differences.

12. The method of claim 11, wherein said means for determining further comprises:
means for generating a sum of the absolute histogram difference ratio based on said comparison of said sum of the absolute histogram difference to said accumulated total of sum of the absolute histogram differences; and
means for generating a sum of the absolute display frame difference ratio based on said comparison of said sum of the absolute display frame difference to said accumulated total of sum of the absolute display frame differences.

13. The method of claim 12, wherein said means for determining further comprises:
means for combining said sum of the absolute histogram difference ratio with said sum of the absolute display frame difference ratio; and
means for determining that said scene change is occurring if said combination is at least equal to a predetermined limit.

14. The apparatus of claim 10, wherein said apparatus is incorporated into a post-production system.

15. The apparatus of claim 14, wherein said post-production system is a color correction system.

16. The apparatus of claim 14, wherein said post-production system is a contrast adjustment system.

17. The apparatus of claim 14, wherein said post-production system is a film grain adjustment system.

18. The apparatus of claim 10, wherein said apparatus is incorporated into an encoding system.
